(19) United States
(12) Patent Application Publication
(10) Pub. No.: US 2014/0033040 A1
(43) Pub. Date: Jan. 30, 2014

(54) PORTABLE DEVICE WITH CAPABILITY FOR NOTE TAKING WHILE OUTPUTTING CONTENT

(71) Applicant: APPLE INC., Cupertino, CA (US)

(72) Inventors: Christian Thomas, Los Gatos, CA (US); Eric B. Bailey, Sunnyvale, CA (US); Jason D. Ediger, Los Gatos, CA (US); Matthew K. Fukuda, San Francisco, CA (US); Michael J. Nino, San Jose, CA (US); William M. Bachman, San Jose, CA (US)

(21) Appl. No.: 13/905,594

(22) Filed: May 30, 2013

Related U.S. Application Data
(60) Provisional application No. 61/675,302, filed on Jul. 24, 2012.

(51) Int. Cl. G06F 3/0488

(52) U.S. Cl. CPC G06F 3/0488; G06F 3/04886
USPC 715/721; 715/773

(57) ABSTRACT

A portable device includes a touch-screen display configured to allow a user to interface with the portable device, and a user input mechanism configured to enable a note-taking mode. Upon entering the note-taking mode, an electronic keypad is displayed in a first area of the touch-screen display, a note-taking window is provided in a second area of the touch-screen display, and a multimedia window for outputting multimedia information is provided in a third area of the touch-screen display.

### CLAIM OF PRIORITY

The present application claims priority under 35 U.S.C. §119(e) to U.S. Provisional Patent Application Ser. No. 61/675,302, filed Jul. 24, 2012, titled “PORTABLE DEVICE WITH CAPABILITY FOR NOTE TAKING WHILE OUTPUTTING CONTENT,” the contents of which are incorporated by reference herein.

### BACKGROUND

The disclosed embodiments relate generally to portable devcies such as tablets and smart phones, and more particuarly to portable devices with capability for note taking while outputting content.

As educational material, such as videos of courses taught by professors, become more widely available on the world wide web, the need for portable devices capable of playing these education material and allowing the user to simultaneously take notes has increased. While computers with such capablities have been in existence, the known techniques are cumbersome to users, particularly in portable devices, thus resulting in poor user experience. Accordingly, there is a need for devcies with capability for note-taking while outpouting content with improved user experience.

### SUMMARY

Certain embodiments are described that provide improved techniques for note taking on a portable device as the portable device outputs content.

According to certain embodiments, a portable device includes a touch-screen display configured to allow a user to interface with the portable device, and a user input mechanism configured to enable a note-taking mode. Upon entering the note-taking mode, an electronic keypad is displayed in a first area of the touch-screen display, a note-taking window is provided in a second area of the touch-screen display, and a multimedia window for outputting multimedia information is provided in a third area of the touch-screen display.

According to certain other embodiments, the portable device further includes a timeline corresponding to the multimedia information displayed in a fourth area of the touch-screen display. The timeline displays a current time position of the multimedia information output in the multimedia window.

The following detailed description together with the accompanying drawings will provide a better understanding of the nature and advantages of the various disclosed embodiments.

### BRIEF DESCRIPTION OF THE DRAWINGS

FIG. 1 is a screen shot of a tablet device showing a multimedia library with exemplary media folders and files, according to some embodiments;

FIG. 2 is a screen shot of a tablet device showing a full screen video in play mode, according to some embodiments;

FIG. 3 is a screen shot of a tablet device in video note-taking mode, according to some embodiments;

FIG. 4 is a screen shot of a tablet device as the user is taking notes with video playing, according to some embodiments;

FIG. 5 is a screen shot of a tablet device showing a multimedia library with certani media files, according to some embodiments;

FIG. 6 is a screen shot of a tablet illustrating how the AirPlay® mode is entered, according to some embodiments;

FIG. 7 is a screen shot of a tablet device in AirPlay® mode immediately after selecting an external screen, according to some embodiments;

FIG. 8 is a screen shot of a tablet device showing a portrait view of the list view corresponding to the landscape view shown in FIG. 5, according to some embodiments;

FIG. 9 is a screen shot of a tablet device showing a portrait view illustrating how the AirPlay® mode is entered, according to some embodiments;

FIG. 10 is a screen shot of a smart phone showing a full screen video in play mode, according to some embodiments;

FIGS. 11A and 11B are screen shots of a smart phone in video note taking mode, according to some embodiments;

FIG. 12 is a screen shot of a smart phone showing a list view in which a list of all notes associated with a video file can be viewed, according to some embodiments;

FIG. 13 is a screen shot of a smart phone in landscape view showing a list view in which a list of all notes associated with a video file can be viewed, according to some embodiments;

FIG. 14 is a simplified block diagram of a computer system that may incorporate components of a system for providing note taking capability while outputting content according to some embodiments;

FIG. 15 is a flow diagram that illustrates an example of a technique for allowing notes to be taken and associated with a point in a video stream while that video stream is being played, according to an embodiment of the invention; and

FIG. 16 is a flow diagram that illustrates an example of a technique for highlighting notes that are associated with bookmarks on a timeline as a play head moves over those bookmarks while a video stream is playing, according to an embodiment of the invention.

It is noted that some of the drawings include illustrative content items, some of which may include content produced or owned by third parties. It is to be understood that such content is used solely for illustrative purposes and should not be viewed as being part of the disclosed embodiment.

### DETAILED DESCRIPTION

In the following description, for the purposes of explanation, specific details are set forth in order to provide a thorough understanding of the various disclosed embodiments. However, it will be apparent that various embodiments may be practiced without these specific details. The figures and description are not intended to be restrictive.

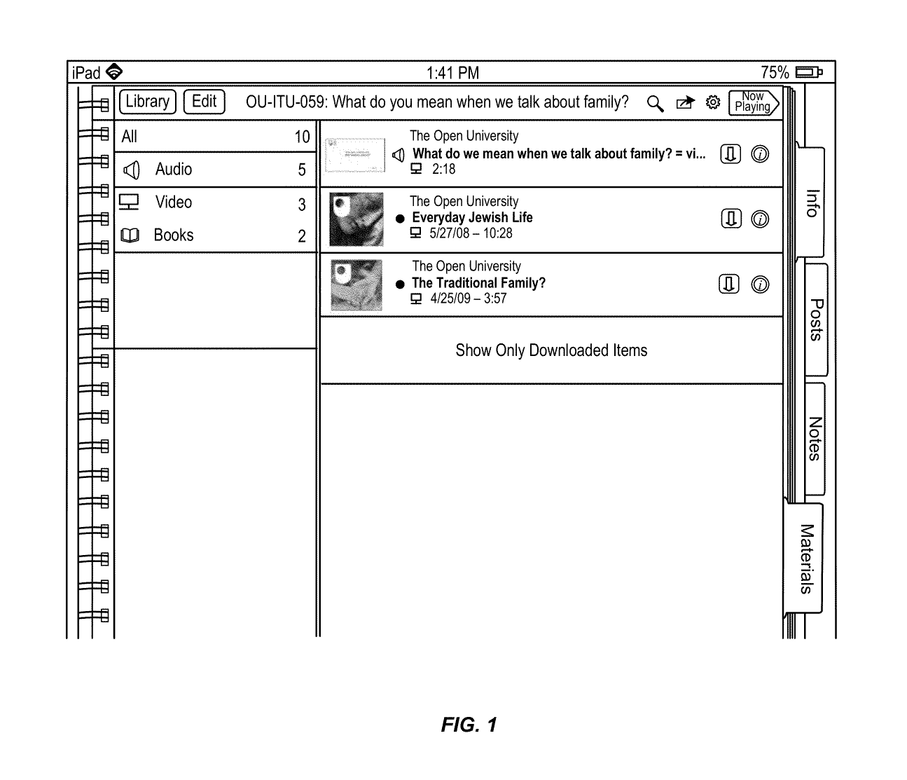

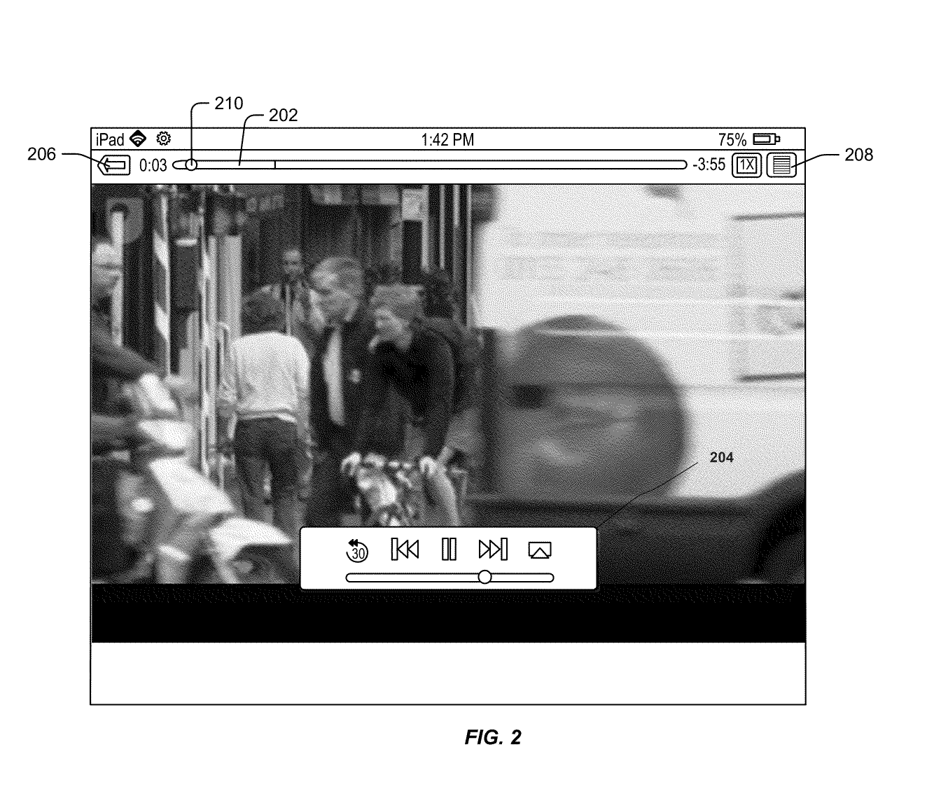

FIGS. 1-9 are screen shots from an iPad® that will be used to describe note taking techniques according to certain embodiments. The FIG. 1 screen shot shows a multimedia library with three media folders: Audio, Videos and Books. Each media folder may contain one or more media files. In the FIG. 1 screen shot, the Videos folder is selected and is shown to contain three video files. Upon selecting the bottom video file titled “The Traditional Family Life” (e.g., by tapping the corresponding thumbnail) the video is launched and the user can start viewing the video stream as shown in FIG. 2. FIG. 2 is a screen shot of the video in full screen play mode. Timeline 202 displaying a current time position of the video stream is provided along the top of the display. Electronic control panel 204 along the bottom of the display allows the user to control various functions related to the playback of the video being displayed. User-selectable button 206 in the upper left corner can be used to navigate back to the previous screen. User-selectable button 208 in the upper right corner can be used to enter the note-taking mode. Alternatively, the note-taking mode can be entered using a hand gesture, e.g., pinching the video screen with two fingers.

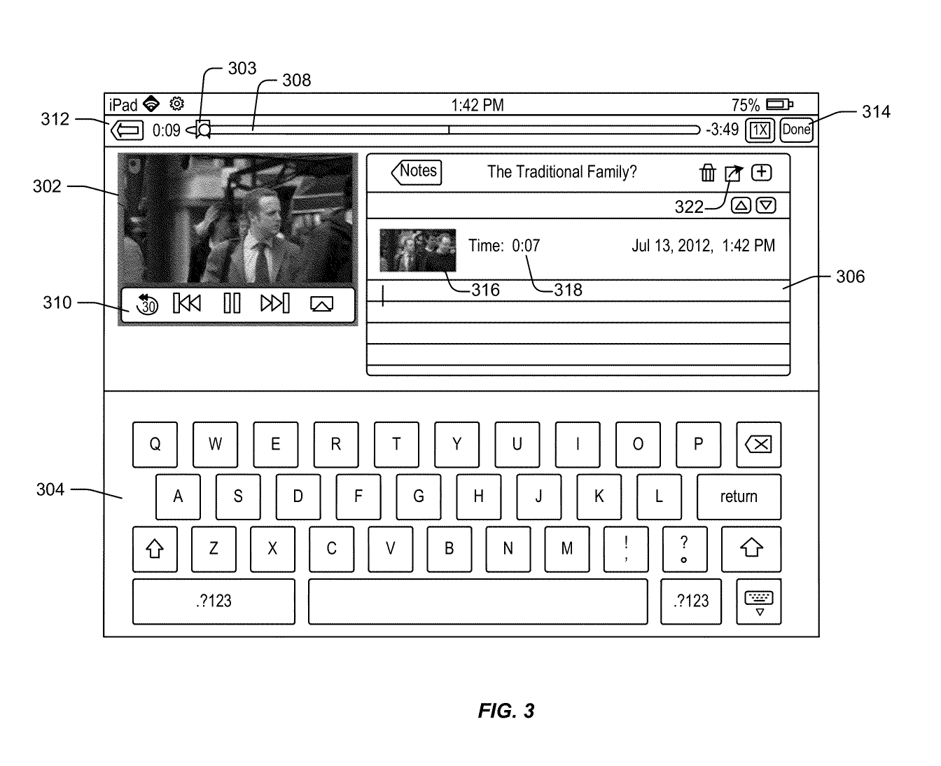

FIG. 3 is a screen shot of the iPad® screen upon entering the video note-taking mode. As can be seen, the video screen is reduced in size and moved to the upper left side of the display, electronic keypad 304 is displayed along the bottom of the display, and note-taking window 306 where the user can take notes is displayed in the upper right portion of the display. Timeline 308 for displaying a current time position of the video stream is also provided along the top of the display. Electronic control panel 310 along the bottom of video screen 302 allows the user to control the video being displayed. User-selectable button 312 in the upper left corner can be used to toggle back to the immediately preceeding screen. User-selectable button 314 in the upper right corner can be used to toggle over to the full screen video (FIG. 2). Alternatively, the user can toggle to the full screen video by a hand gesture, e.g., by moving two fingers apart over video screen 302.

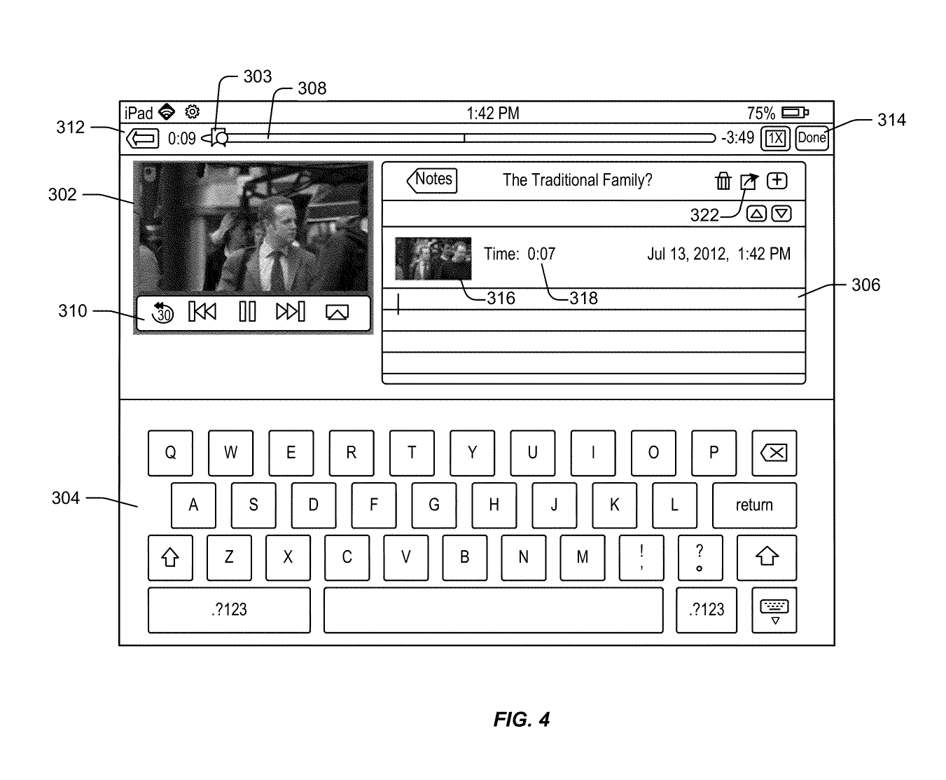

In certain embodiments, the note taking process can be as follows. As the user watches the video on video screen 302 and reaches a point in the video where she would like to start taking notes, she can tap the “+” button in the upper right corner of note-taking window 306. Tapping the “+” button creates a bookmark 303 and enables the user to start typing a note in note-taking window 306 using electronic keypad 304. A thumbnail 316 of the video image at the time the bookmark is created together with a video time stamp 318 associated with the video image may be displayed in note-taking window 306. FIG. 4 shows a screen shot after the user has typed the note “This is about expectations” using electronic keypad 304. This note is linked with thumbnail 316 and time stamp 318. The video can continue playing on video screen 302 as the user enters the notes. In another embodiment, the user can use the pause/play button in control panel 310 to pause the video during note-taking, and resume the video when finished with note taking. In still another embodiment, the video could automatically be paused, or play at half speed, when typing starts, and automatically resume normal play a certain period of time (e.g., few seconds) after typing stops. The user can move the video forward or backward and enter more notes. Additionally, the user can share her notes with others via email, Twitter, Facebook or other similar means by tapping user-selectable button 322. In certain embodiments, a URL to the video file can be included in the message being sent together with the time stamps for each note. This allows the recipient to quickly go to the segment of the video stream corresponding to each note. In other embodiments, a short segment of video (e.g., 30 seconds before and after) may be included with the shared note.

In FIG. 4, the user can tap bookmark 303 to start viewing the video stream at the corresponding time in the video stream, and the corresponding note is displayed in note-taking window 306. In certain embodiments, bookmark 303 can be moved to another location along timeline 308, thus providing the user the flexibility to associate the note with a different time point in the video stream. In certain other embodiments, the user can duplicate (e.g., copy/paste) bookmark 303 at another location along timeline 308, and the notes associated with the original and the duplicated bookmarks can be independently edited.

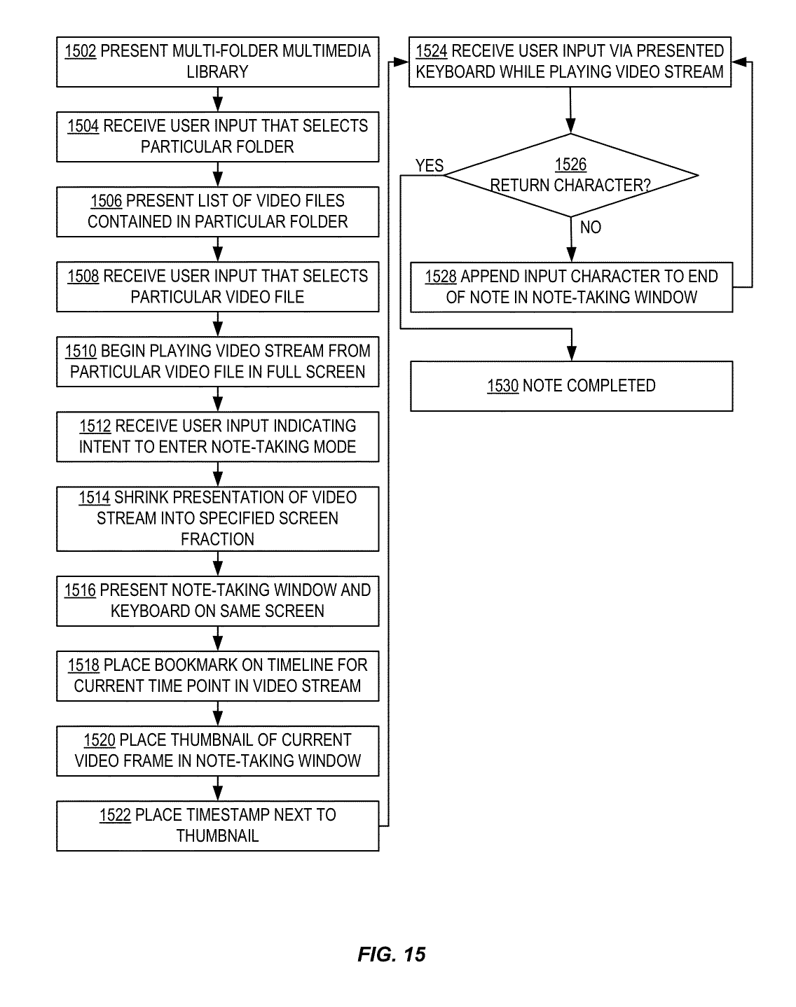

FIG. 15 is a flow diagram that illustrates an example of a technique for allowing notes to be taken and associated with a point in a video stream while that video stream is being played, according to an embodiment of the invention. Although certain operations are shown as being performed in a certain order as part of the technique, alternative embodiments can include additional, fewer, or different operations being performed in potentially a different order. In block 1502, a device presents a multimedia library including multiple folders. In block 1504, the device receives user input that selects a particular folder. In block 1506, the device presents a list of video files that are contained within the particular folder. In block 1508, the device receives user input that selects a particular video file. In block 1510, the device begins to play a video stream from the particular video file in full-screen mode. In block 1512, the device receives user input (e.g., tapping on button 208 or making a pinching gesture relative to the video presentation) that indicates user intent to enter a note-taking mode. In block 1514, the device shrinks the presentation of the playing video stream into a specified fraction of the screen that is smaller than the area of the screen that the presentation occupied at of block 1510. In block 1516, the device presents, on the same screen as the shrunken video presentation, a note-taking window and an electronic (graphical) keypad. In block 1518, the device places, on a timeline displayed on the screen, a bookmark at a position representative of the time point corresponding to a particular frame in the video stream that is currently being presented. In block 1520, the device places a thumbnail of the particular frame in the note-taking window. In block 1522, the device places, next to the thumbnail in the note-taking window, a timestamp indicating a quantity of time that elapses during uninterrupted normal speed playing from the beginning of the video stream to the time point at which the particular frame occurs in the video stream. In block 1524, the device receives user input representing a character via the electronic keyboard while continuing the play the video stream in the specified fraction. In block 1526, the device determines whether the character is a “return” character. If so, then control passes to block 1530. Otherwise, control passes to block 1528. In block 1528, the device appends (unless the user input reflected a backspace or deletion) the character to an end of a user-generated note presented next to the thumbnail in the note-taking window while continuing to play the video stream in the specified fraction. If the user input reflected a backspace or deletion, then the device removes an appropriate character from the node. Control passes back to block 1526. Alternatively, in block 1530, the user-generated note is completed, and the technique illustrated in FIG. 15 ends. The device can continue to play the video stream in the specified fraction until the device detects user input indicating the user's intent to cause the device to return to full-screen mode.

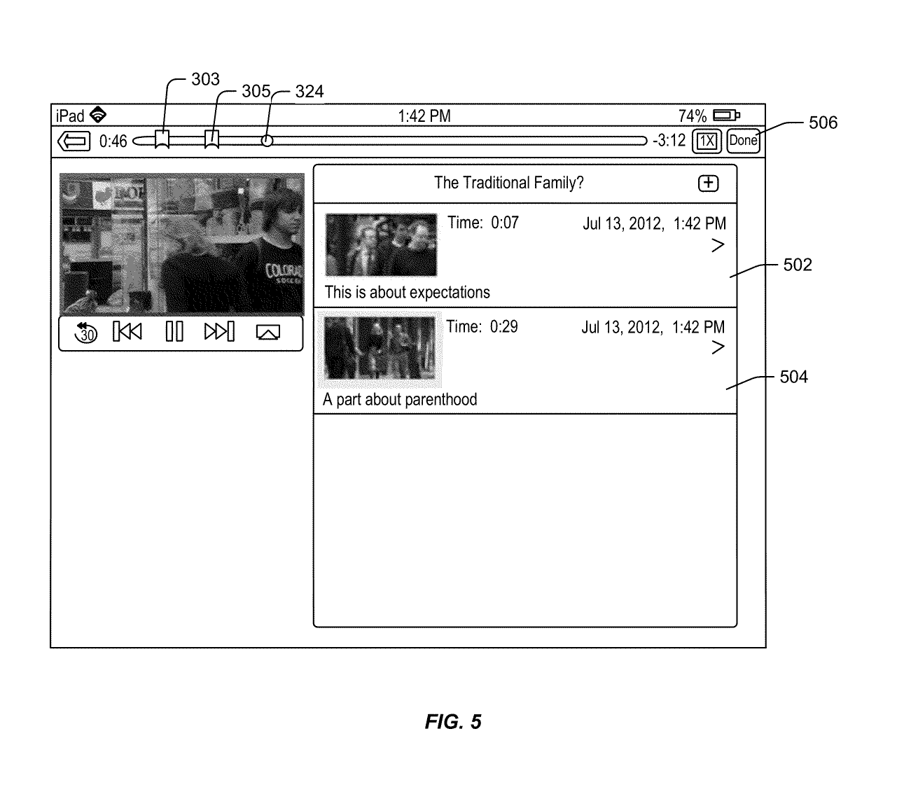

FIG. 5 shows a screen shot of a list view in which a list of all notes associated with a video file can be viewed. The list view can be displayed by tapping “Notes” button 320 in note-taking window 306 (FIG. 4). In the list view, the electronic keypad is removed and a listing of the thumbnails together with their associated time stamp and an excerpt of the associated note is displayed. The user can drill down (e.g., for viewing the full note or to edit a note) by tapping the desired note. The screen shot in FIG. 5 shows two notes 502 and 504 and two corresponding bookmarks 303 and 305 associated with the video being displayed. If more notes are present in the list view than can be displayed on one screen at once, the user can scroll up or down to reach the desired note by using hand gestures (e.g., swipe two fingers up over the list to scroll up or swipe two fingers down to scroll down). In certain embodiments, as play-head 324 moves over each bookmark, the corresponding note is highlighted. The user can thus see the notes that are linked to corresponding video segments as she watches the video. User-selectable button 506 in the upper right corner can be used to toggle over to the full screen video (FIG. 2). Alternatively, the user can toggle to the full screen video by a hand gesture, e.g., by moving two fingers apart over video screen 302.

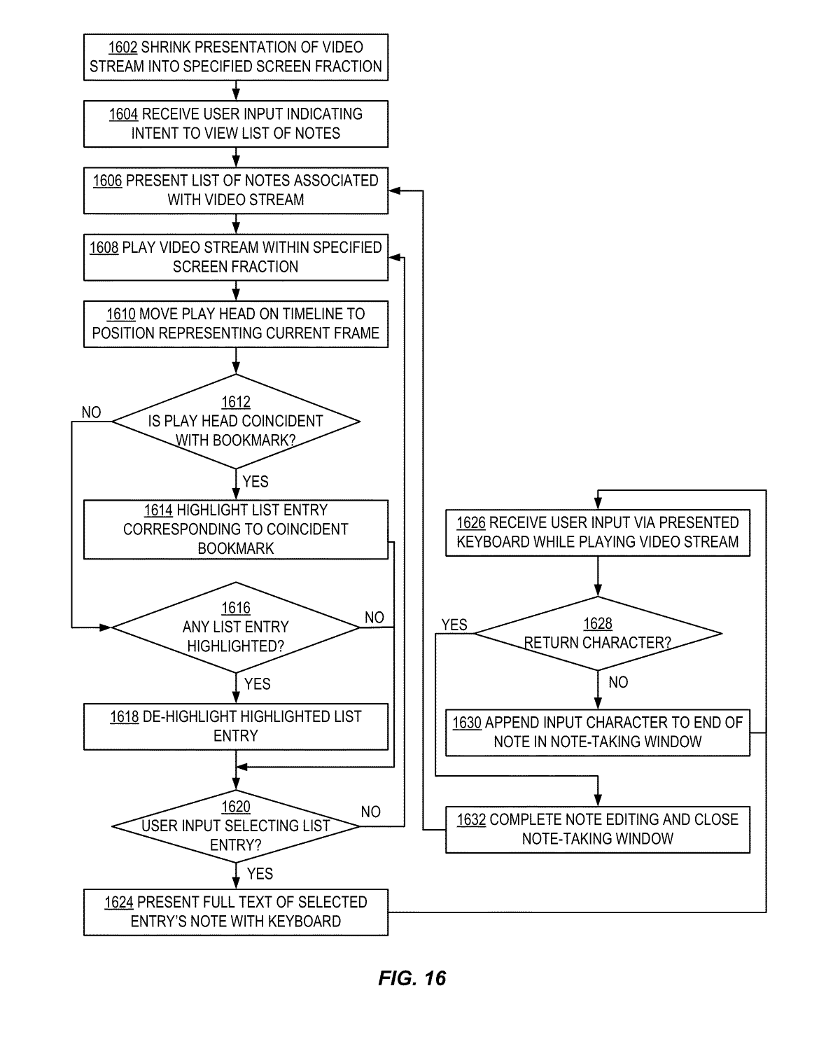

FIG. 16 is a flow diagram that illustrates an example of a technique for highlighting notes that are associated with bookmarks on a timeline as a play head moves over those bookmarks while a video stream is playing, according to an embodiment of the invention. Although certain operations are shown as being performed in a certain order as part of the technique, alternative embodiments can include additional, fewer, or different operations being performed in potentially a different order. In block 1602, the device shrinks the presentation of a playing video stream into a specified fraction of the screen that is smaller than the full area of the screen that the presentation occupies in full-screen mode. In block 1604, the device receives user input indicating user intent to view a list of notes associated with the video stream. In block 1606, the device presents, on the same screen as the fractional video presentation, and for each note in the list of notes associated with the video stream (generated using the technique discussed above in connection with FIG. 15), a list entry containing that note's thumbnail and timestamp. Each list entry can contain part or the entirety of the textual note itself. In block 1608, the device plays (or continues playing) the video stream within the specified fraction of the screen. In block 1610, the device moves a play head on a timeline to a position representing the currently presented video frame. In block 1612, the device determines whether the play head is coincident with a bookmark on the timeline. If so, then control passes to block 1614. Otherwise, control passes to block 1616. In block 1614, the device highlights the list entry corresponding to the note that is associated with the coincident bookmark. Control passes to block 1620. Alternatively, in block 1616, the device determines whether any list entry is currently highlighted. If so, then control passes to block 1618. Otherwise, control passes to block 1620. In block 1618, the device de-highlights the currently highlighted list entry. Control passes to block 1620. In block 1620, the device determines whether user input selecting a particular list entry has been received. If so, then control passes to block 1624, in which user editing of an existing note can commence. Otherwise, control passes back to block 1608. In block 1624, the device presents (a) the full text of the particular list entry's note in a note-taking window and (b) an electronic (graphical) keyboard. In block 1626, the device receives user input representing a character via the electronic keyboard while continuing the play the video stream in the specified fraction. In block 1628, the device determines whether the character is a “return” character. If so, then control passes to block 1632. Otherwise, control passes to block 1630. In block 1630, the device appends (unless the user input reflected a backspace or deletion) the character to an end of a user-generated note presented next to the thumbnail in the note-taking window while continuing to play the video stream in the specified fraction. If the user input reflected a backspace or deletion, then the device removes an appropriate character from the node. Control passes back to block 1626. Alternatively, in block 1632, the editing of the particular list entry's note is completed, and the device closes the note-taking window and obscures the keyboard. Control passes back to block 1606.

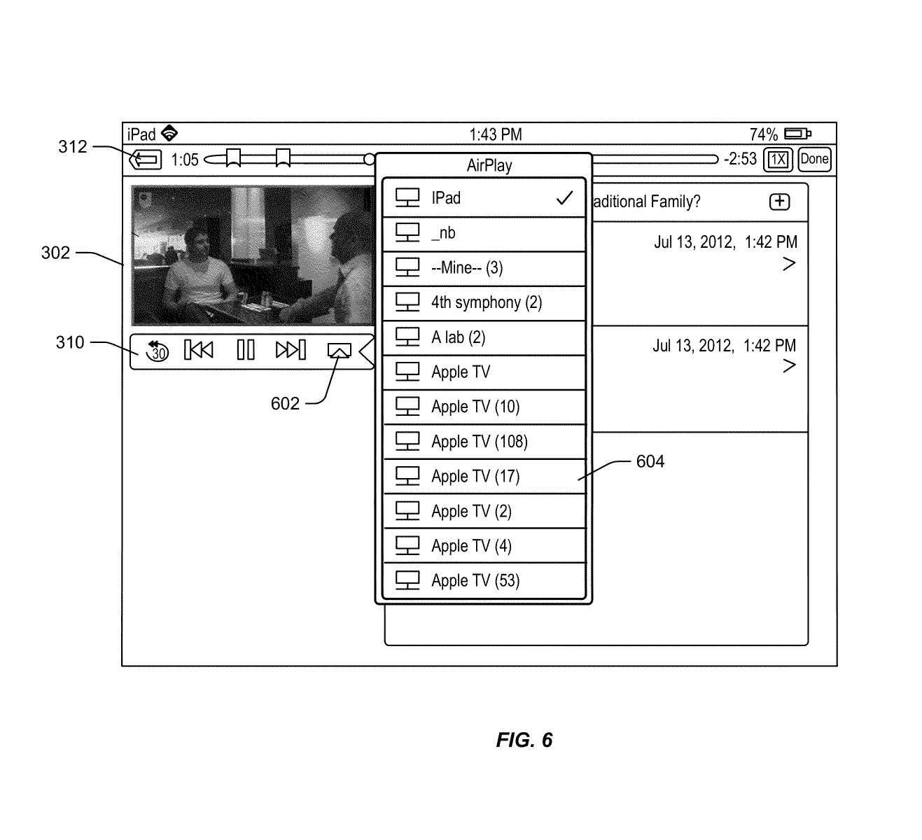

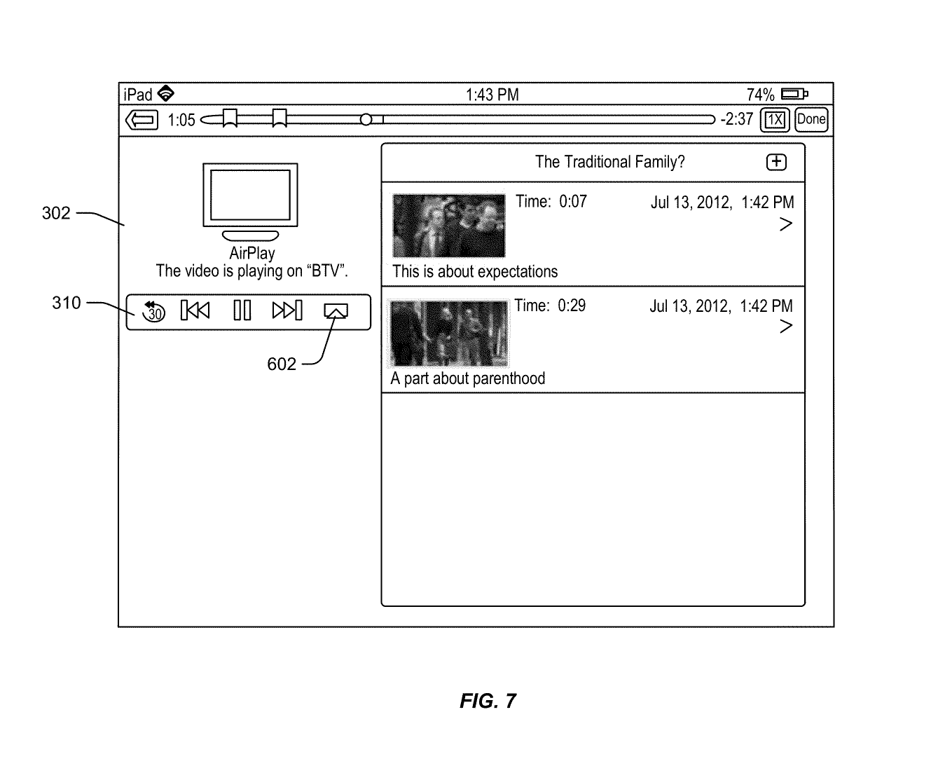

In certain embodiments, an AirPlay® mode enables the user to view the video stream on an external screen (e.g., another monitor or TV) while taking notes on the iPad®. This enables the user to view the video on a larger screen. The FIG. 6 screen shot illustrates how the AirPlay® mode is entered. The AirPlay® mode can be entered by tapping AirPlay® button 602 in control panel 310 of video display 302. Upon tapping AirPlay® button 602, a menu 604 of available options for external viewing of the video is displayed. Upon tapping one of the options, the video starts playing on the selected external screen. The FIG. 7 screen shot shows the iPad® display immediately after selecting an external screen. As can be seen, video screen 302 in FIG. 7 does not show the video stream and instead displays a message indicating that the video is in AirPlay® mode and identifying the external source on which the video is being played. When in AirPlay® mode, the color of AirPlay® button 602 is changed to a different color than the other user-selectable buttons in control panel 310. The video can be brought back to the iPad® by tapping AirPlay® button 602. In certain embodiments, in AirPlay® mode, the video screen on the iPad® is reduced in size (or eliminated) during note taking so that the user has more space for taking notes.

In certain embodiments, in the full screen view of the video stream (FIG. 2), as play-head 210 moves over each bookmark (not present in the FIG. 2 screen shot), a popover automatically appears on the screen with corresponding notes. This eliminates the need to tap on a bookmark to drill down and view the notes. During the time period a popover appears on the screen, the user can tap on the popover to get in edit mode for editing the note.

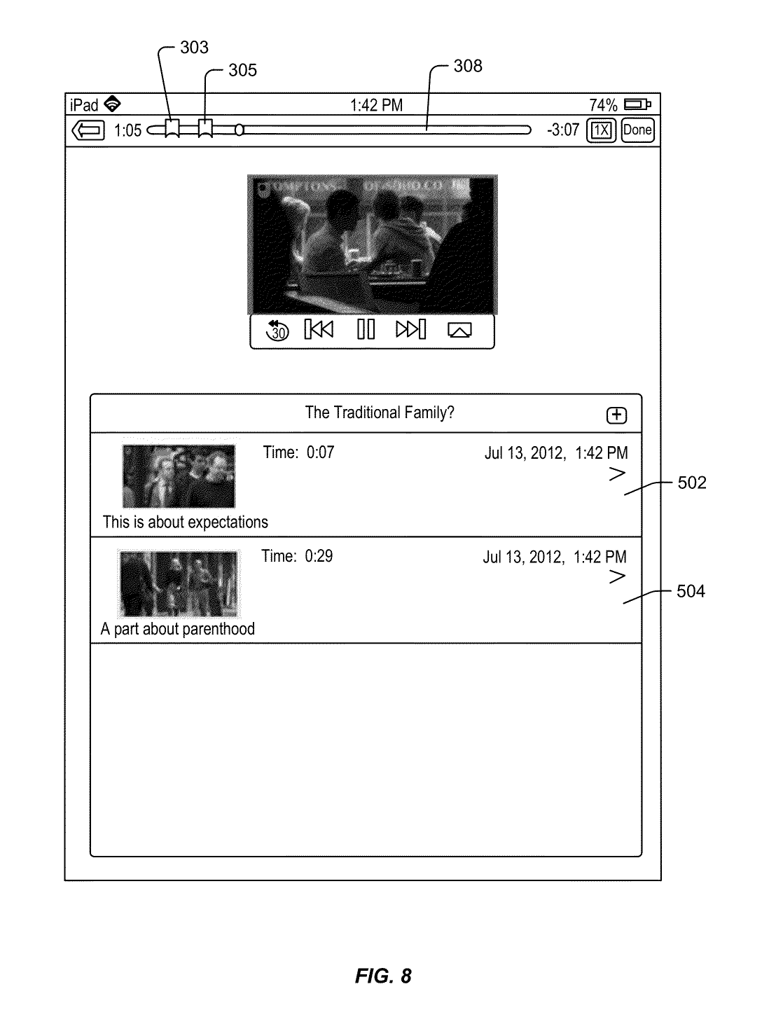

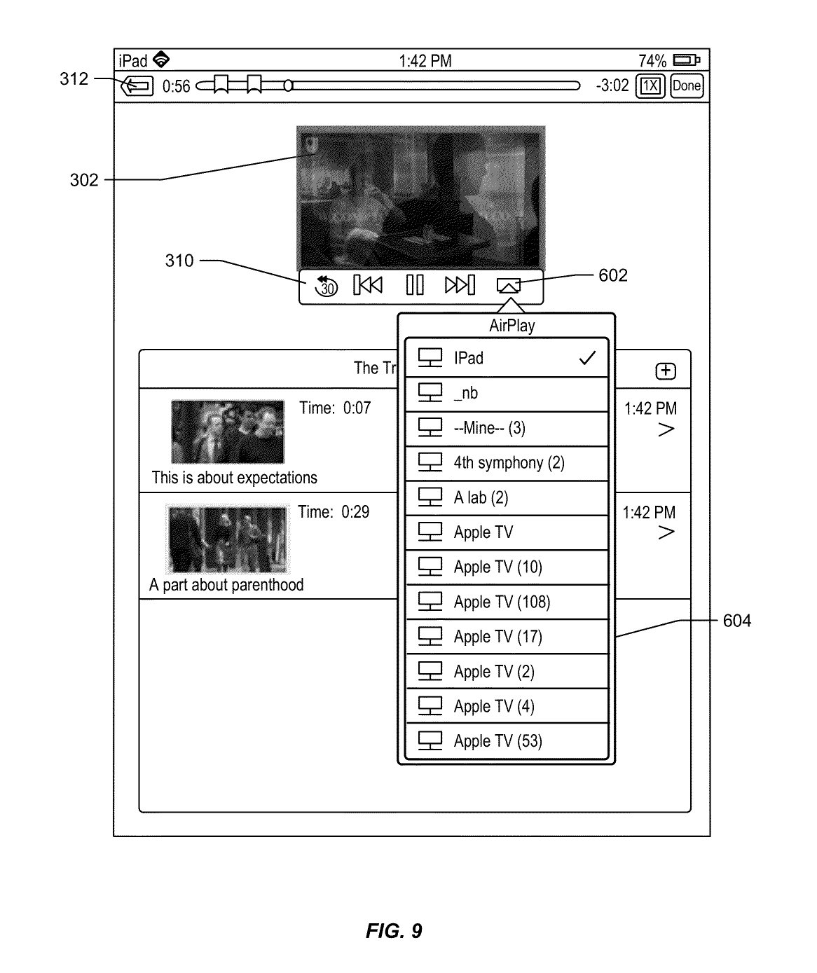

While all the screen shots described above are in landscape view, the same features and content can be viewed in portrait view. As an example, the FIG. 8 screen shot shows a portrait view of the list view corresponding to the landscape view shown in FIG. 5. As another example, the FIG. 9 screen shot shows a portrait view illustrating how the AirPlay® mode is entered, and corresponds to the landscape view shown in FIG. 6. While the size and location of various windows may differ between the landscape and portrait views, the content as well as the available utilities may remain unchanged.

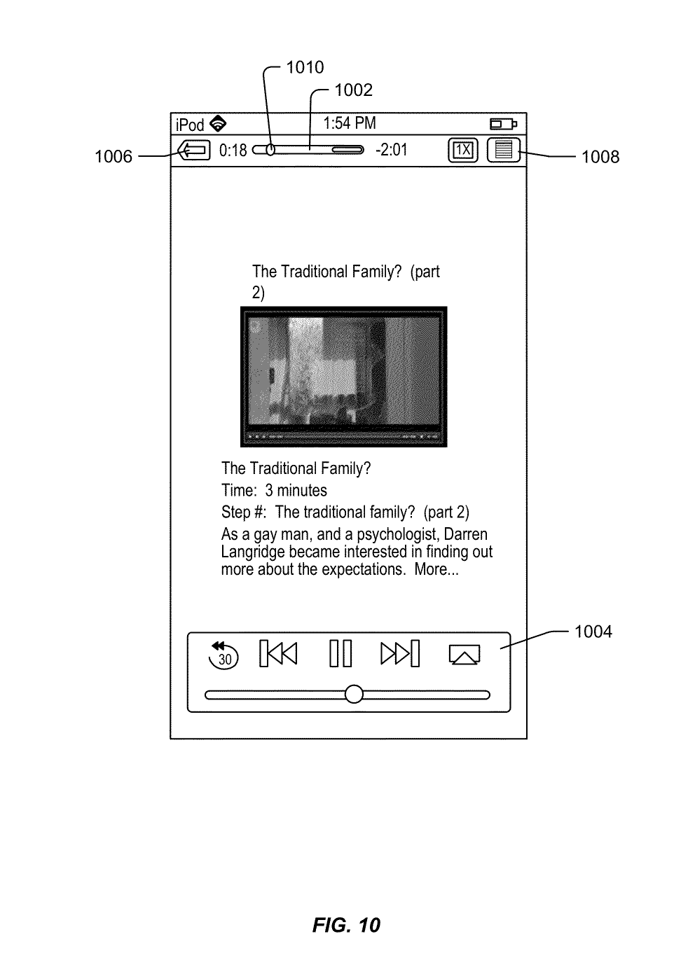

While the above-described note taking features are described in the context of a tablet, they can also be provided on a smart phone, such as an iPhone®. FIGS. 10, 11A, 11B, 12 and 13 are screen shots of an iPhone® screen illustrating the views and functionality of note-taking on an iPhone®. The FIG. 10 screen shot shows the full screen view of the video stream, and corresponds to the FIG. 2 screen shot of the iPad®. Timeline 1002 showing a current time position of the video stream is displayed along the top of the display. Electronic control panel 1004 along the bottom of the display allows the user to control the video being displayed. User-selectable button 1006 in the upper left corner can be used to toggle back to the previous screen. User-selectable button 1008 in the upper right corner can be used to enter the note-taking mode. Alternatively, the note-taking mode can be entered using a hand gesture, e.g., pinching the video screen with two fingers.

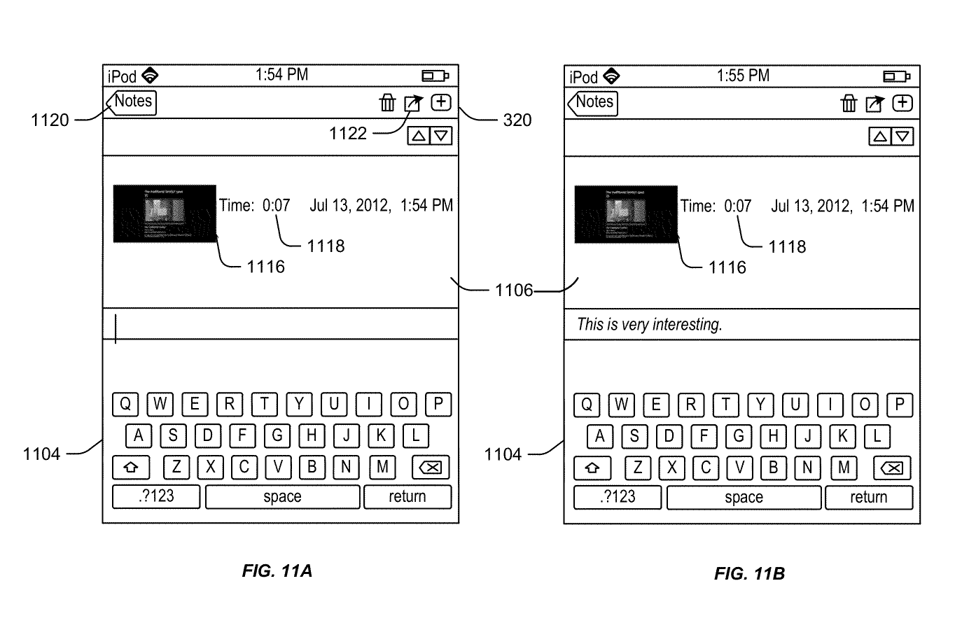

FIG. 11A is a screen shot of the iPhone® upon entering the video note-taking mode. As can be seen, electronic keypad 1104 is displayed along the bottom of the display, and note-taking window 1106 where the user can take notes is displayed above keypad 1104. The video screen is eliminated to provide sufficient space for note taking, though in certain embodiments, note-taking window 1106 could be made smaller to accommodate a window for the video.

In certain embodiments, the note taking process can be as follows. In FIG. 10, as the user watches the video and reaches a point in the video where she would like to start taking notes, she can tap user-selectable button 1008 (FIG. 10) to enter the note taking mode (FIG. 11A). A bookmark is created and the user can start typing a note in note-taking window 1106 using electronic keypad 1104. A thumbnail 1116 of the video image on display at the time the bookmark was created together with a video time stamp 1118 of when the bookmark was created are displayed in note-taking window 1106. FIG. 11B shows a screen shot after the user has completed typing the note: “This is very interesting.” This note is linked to the bookmark, to thumbnail 1116 and to video time stamp 1118. As the user enters notes, the video can continue playing in the background (video not visible but audio playing). After finishing the note, the user can continue to listen to the audio and create another bookmark by tapping the “+” button in upper right corner of note-taking window 1106, and start typing another note in the note-taking window. In certain embodiments, in FIG. 10, just before entering the note-taking mode, the user can pause the video by tapping the pause/play button in control panel 1004, enter note-taking mode by tapping button 1008, enter notes in window 1106 (FIG. 11B), and after completing the note, return to full screen video screen and tap the pause/play button to resume watching the video. In certain embodiments, the video could automatically be paused, or play at half speed, when user-selectable button 1008 is tapped for getting into note-taking mode, and a certain period of time (e.g., few seconds) after the user stops typing the screen is automatically changed to the full screen video and normal play is resumed. The user can move the video forward or backward and enter more notes. Additionally, the user can share her notes with others via email, tweeter, Facebook or other similar means by pressing user-selectable button 1122. In certain embodiment, a URL to the video file can be included in the message being sent together with the time stamp for each note.

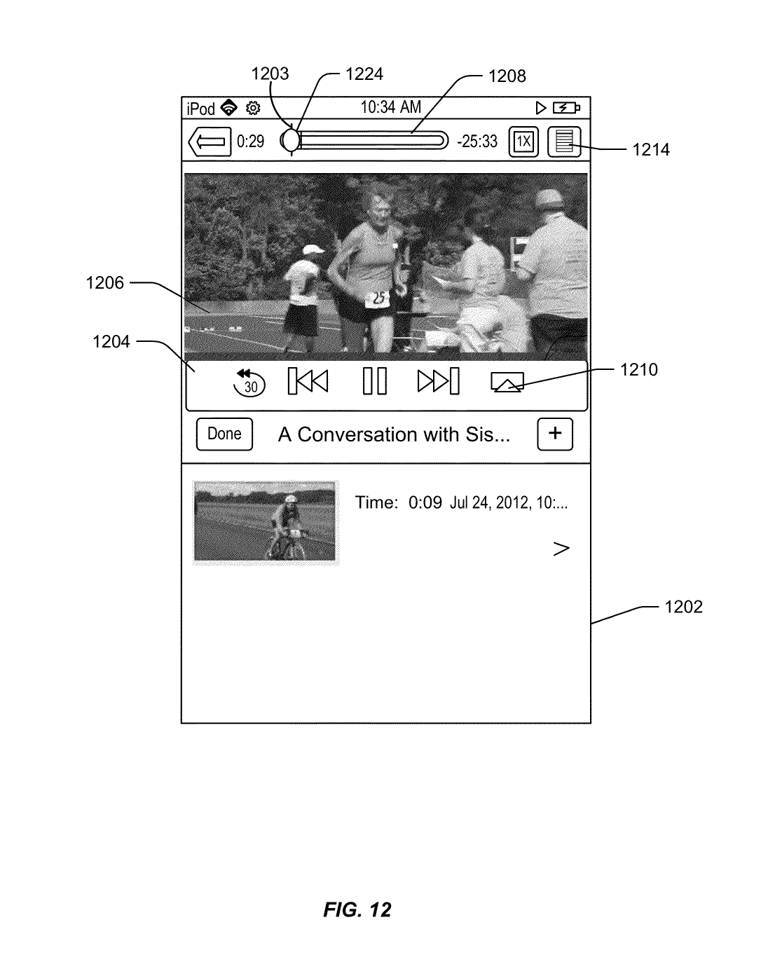

FIG. 12 shows a screen shot of a list view in which a list of all notes associated with a video file can be viewed. The list view is accessed by tapping “Notes” button 1120 in note-taking window 1106 (FIG. 11A). In the list view, the electronic keypad is removed, the video window is displayed, and for the given video file being played, a listing of the thumbnails together with their associated time stamp and an excerpt of the associated note are displayed. The user can drill down (e.g., for viewing the full note or to edit a note) by tapping the desired note. The screen shot in FIG. 12 shows a note corresponding to bookmarks 1203. Other notes (if present) can be viewed by scrolling down (e.g., by using a two-finger swiping gesture over the note area) until the note is in view.

In FIG. 12, the user can tap a bookmark to start viewing the video stream at the corresponding time in the video stream, and the corresponding note is highlighted in the list view. In certain embodiments, as play-head 1224 moves over each bookmark, the corresponding note in the list view is highlighted. In the FIG. 12 screen shot, play-head 1224 is directly over bookmark 1203, and the corresponding note 1202 is highlighted. In certain other embodiments, the bookmarks can be moved to another location along timeline 1208, or duplicated (e.g., copy/paste) at another location along timeline 1208. In certain other embodiments, in the full screen view of the video stream (FIG. 10), as play-head 1010 moves over each bookmark (none are present in the FIG. 10 screen shot), a popover automatically appears on the screen with the corresponding note. This eliminates the need to drill down to reach the note for a given bookmark. During the time period a popover appears on the screen, the user can tap on the popover to get in edit mode for editing the note. User-selectable button 1214 in the upper right corner can be used to toggle over to the full screen video (FIG. 10). Alternatively, the user can toggle to the full screen video by a hand gesture, e.g., by moving two fingers apart over video screen 1206.

Going back to the note-taking screen shot shown in FIG. 11A, from this screen, the user can get back to the full screen video (FIG. 10) but tapping “Notes” button 1120, which takes the user to the list view screen (FIG. 12), and then from the list view screen, the user can tap user-selectable button 1214 to reach the full screen video (FIG. 10). In certain other embodiments, a user-selectable button similar in functionality to button 1214 (FIG. 12) may be incorporated in the note-taking screen shot shown in FIG. 11A to thereby allow the user to directly toggle over to the full screen video (FIG. 10).

In certain embodiments, the AirPlay® mode discussed above in the context of a tablet, may be incorporated in smart phones such as an iPhone®. This would enable the user of the smart phone to view the video stream on an external screen (e.g., another monitor or TV) while taking notes on the smart phone. In this manner, the video can potentially be viewed on a larger screen. In the FIG. 12 screen shot (view list), AirPlay® mode can be entered by tapping AirPlay® button 1210 in the electronic control panel 1204. Upon tapping AirPlay® button 1210, a menu (not shown) of available options for external viewing of the video is displayed, similar to that shown in FIG. 9. Upon tapping one of the options, the video starts playing on the selected external screen. Once the video starts playing on the external screen, video screen 1206 in FIG. 12 does not show the video stream and instead displays a message indicating that the video is in AirPlay® mode and identifies the external source on which the video is being played (similar to that shown in FIG. 7. The video can be brought back to the iPhone® by tapping AirPlay® button 1210.

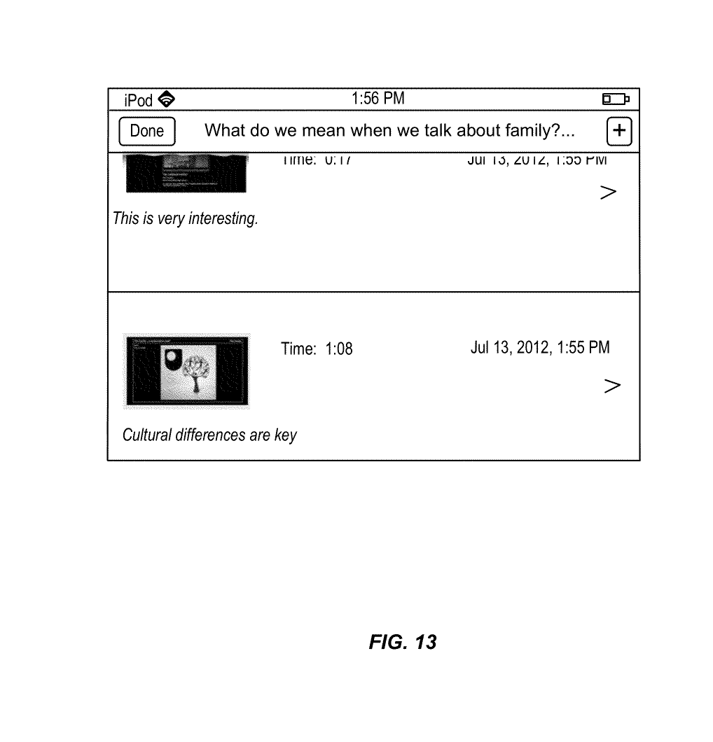

Although the screen shots in FIGS. 10, 11A, 11B and 12 are portrait views, much of the same features and functionality are available in landscape view. As an example, the FIG. 13 screen shot shows a landscape view of the list view. In this exemplary embodiment, the video screen is eliminated in the list view, but in other embodiments, the video screen can be incorporated in the landscape view of the list view. While the size and location of various windows may differ between the landscape and portrait views, the content as well as the available utilities may remain unchanged.

In the above exemplary embodiments, the video source can be a class lecture video, YouTube video, or other sources from which video can be streamed. The video note taking features are particularly helpful to students in that they can see a thumbnail of all notes they took in viewing the video lecture and can go back to any bookmark by hitting the corresponding time stamp and view the notes and the corresponding video.

In certain embodiments, bookmarks can be crowd sourced. For example, a histogram of the bookmarks showing which portions of a video received the most bookmarks can be used to identify those video portions that generated most notes.

While the above exemplary embodiments show the manner by which a user can take notes while viewing a video stream, the embodiments of the invention are not limited as such. For example, a user may take notes while listening to an audio file in a similar manner to the techniques described above. As another example, a user can take notes while viewing pages of a presentation document with audio describing the contents of the pages of presentation.

In certain embodiments, students are provided direct access (electronically) to private live courses. A unique code is generated for each course. A student can type the code on her iPad® and the professor can see that the student is attempting to enroll in the class. Once the professor presses an appropriate button, a push notification is provided to the student indicating that the student can enroll in the course, or the request is denied. This methodology is particularly useful for private live classes, and provides an easy means for students to directly enroll in a class without having to go through an educational institution.

While in the above exemplary embodiments text-based notations are shown being input by the user (e.g., in FIG. 4 or FIG. 11B screen shots), other types of information can be input, such as, URL links, PDF links, photos (uploaded from the iPad® or snapped by iPad's® camera), location data, maps, audio notes, pointers to other audio and video files on the web (e.g., YouTube), and identify a person in a video and associate that person with a user profile on sites such as Facebook or Twitter. Also, while in the above exemplary embodiments, a keypad is shown as the mechanism by which the user inputs notes, notes can be input in other ways as well. For example, audio dictation can be used to enter notes or a pen-based screen can be provided that would allow the user to write in text, math formulas or draw pictures. In certain other embodiments, the capability is provided to directly input information (e.g., input text or draw) on top of the video as it is playing in full screen mode. In some embodiments, close captioning can be added under the thumbnail in, for example, FIG. 3 or FIG. 11A, to provide a sense of the content being output at that point in time.

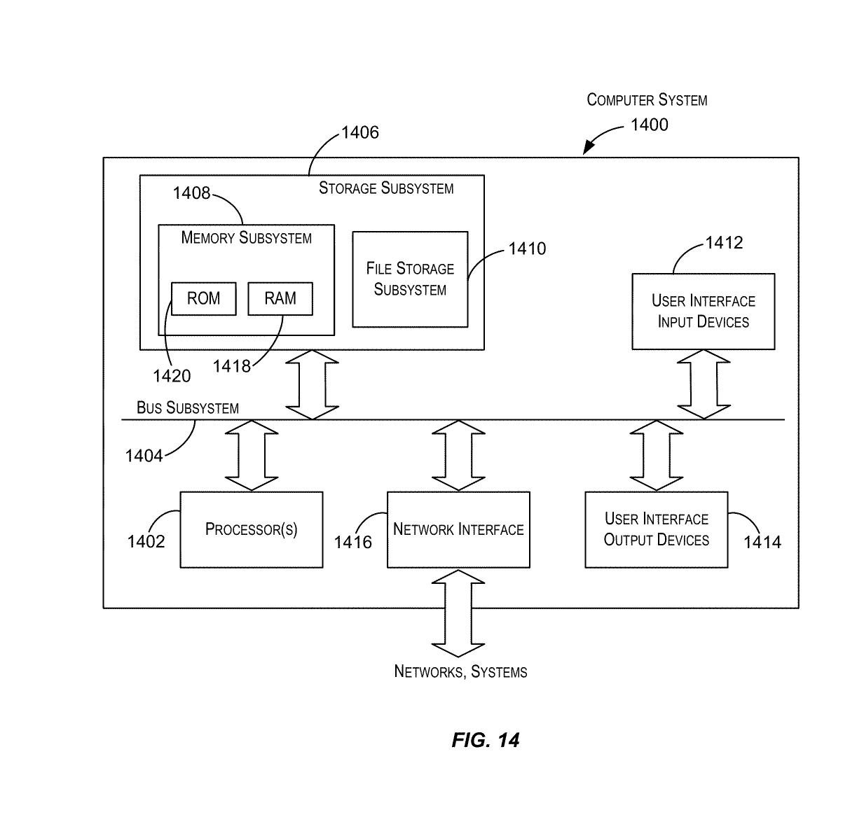

FIG. 14 is a simplified block diagram of a computer system that may incorporate components of a system for providing the above described note taking features according to some embodiments. Computer system 1400 includes one or more processors 1402 that communicate with a number of peripheral subsystems via a bus subsystem 1404. These peripheral subsystems may include a storage subsystem 1406, including a memory subsystem 1408 and a file storage subsystem 1410, user interface input devices 1412, user interface output devices 1414, and a network interface subsystem 1416.

Bus subsystem 1404 provides a mechanism for letting the various components and subsystems of computer system 1400 communicate with each other as intended. Although bus subsystem 1404 is shown schematically as a single bus, alternative embodiments of the bus subsystem may utilize multiple busses.

Processor 1402, which can be implemented as one or more integrated circuits (e.g., a conventional microprocessor or microcontroller), controls the operation of computer system 1400. One or more processors 1402 may be provided. These processors may include single core or multicore processors. In various embodiments, processor 1402 can execute a variety of programs in response to program code and can maintain multiple concurrently executing programs or processes. At any given time, some or all of the program code to be executed can be resident in processor(s) 1402 and/or in storage subsystem 1406. Through suitable programming, processor(s) 1402 can provide various functionalities described above.

Network interface subsystem 1416 provides an interface to other computer systems and networks. Network interface subsystem 1416 serves as an interface for receiving data from and transmitting data to other systems from computer system 1400. For example, network interface subsystem 1416 may enable computer system 1400 to connect to one or more devices via the Internet. In some embodiments network interface 1416 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments, network interface 1416 can provide wired network connectivity (e.g., Ethernet) in addition to or instead of a wireless interface.

User interface input devices 1412 may include a keypad, pointing devices such as a mouse or trackball, a touchpad or touch screen incorporated into a display, a scroll wheel, a click wheel, a dial, a button, a switch, a keypad, audio input devices such as voice recognition systems, microphones, and other types of input devices. In general, use of the term “input device” is intended to include all possible types of devices and mechanisms for inputting information to computer system 1400. For example, in an iPhone®, user input devices 1412 may include one or more buttons provided by the iPhone®, a touch screen, which may display a software keypad, and the like. The software keypad may include a dynamic character key where a character associated with the dynamic character key can be dynamically changed based upon the context.

User interface output devices 1414 may include a display subsystem, indicator lights, or non-visual displays such as audio output devices, etc. The display subsystem may be a cathode ray tube (CRT), a flat-panel device such as a liquid crystal display (LCD), a projection device, a touch screen, and the like. In general, use of the term “output device” is intended to include all possible types of devices and mechanisms for outputting information from computer system 1400. For example, a software keypad may be displayed using a flat-panel screen.

Storage subsystem 1406 provides a computer-readable storage medium for storing the basic programming and data constructs that provide the functionality of some embodiments. Storage subsystem 1406 can be implemented, e.g., using disk, flash memory, or any other storage media in any combination, and can include volatile and/or non-volatile storage as desired. Software (programs, code modules, instructions) that when executed by a processor provide the functionality described above may be stored in storage subsystem 1406. These software modules or instructions may be executed by processor(s) 1402. Storage subsystem 1406 may also provide a repository for storing data used in accordance with the present invention. Storage subsystem 1406 may include memory subsystem 1408 and file/disk storage subsystem 1410.

Memory subsystem 1408 may include a number of memories including a main random access memory (RAM) 1418 for storage of instructions and data during program execution and a read only memory (ROM) 1420 in which fixed instructions are stored. File storage subsystem 1410 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like memory storage media.

Computer system 1400 can he of various types including a personal computer, a portable device (e.g., an iPad®, an iPhone®), a workstation, a network computer, a mainframe, a kiosk, a server or any other data processing system. Due to the ever-changing nature of computers and networks, the description of computer system 1400 depicted in FIG. 14 is intended only as a specific example. Many other configurations having more or fewer components than the system depicted in FIG. 14 are possible.

Various embodiments described above can be realized using any combination of dedicated components and/or programmable processors and/or other programmable devices. The various embodiments may be implemented only in hardware, or only in software, or using combinations thereof. The various processes described herein can be implemented on the same processor or different processors in any combination. Accordingly, where components or modules are described as being configured to perform certain operations, such configuration can he accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter-process communication, and different pairs of processes may use different techniques, or the same pair of processes may use different techniques at different times. Further, while the embodiments described above may make reference to specific hardware and software components, those skilled in the art will appreciate that different combinations of hardware and/or software components may also be used and that particular operations described as being implemented in hardware might also be implemented in software or vice versa.

The various embodiments are not restricted to operation within certain specific data processing environments, but are free to operate within a plurality of data processing environments. Additionally, although embodiments have been described using a particular series of transactions, this is not intended to be limiting. Furthermore, computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although specific embodiments have been described, the invention is intended to cover all modifications and equivalents within the scope of the following claims.

What is claimed is:

1. A portable device comprising:
a touch-screen display configured to allow a user to interface with the portable device; and
a user input mechanism configured to enable a note-taking mode, wherein upon entering the note-taking mode, an electronic keypad is displayed in a first area of the touch-screen display, a note-taking window is provided in a second area of the touch-screen display, and a multimedia window for outputting multimedia information is provided in a third area of the touch-screen display.

2. The portable device of claim 1 further comprising a timeline corresponding to the multimedia information displayed in a fourth area of the touch-screen display, the timeline displaying a current time position of the multimedia information output in the multimedia window.

3. A portable device comprising:
a touch-screen display configured to allow a user to interface with the portable device; and
a user input mechanism configured to enable a note-taking mode, wherein upon entering the note-taking mode, an electronic keypad is displayed in a first area of the touch-screen display, a note-taking window is provided in a second area of the touch-screen display, a window for displaying a video is provided in a third area of the touch-screen display, and a timeline corresponding to the video is displayed in a fourth area of the touch-screen display, the timeline displaying a current time position of the video.

4. The portable device of claim 3 further comprising a user input mechanism for creating a bookmark, a thumbnail of the video image at the time the bookmark is created, and a time stamp of the point in time in the video when the bookmark is created.

5. The portable device of claim 3 further comprising a user input mechanism configured to provide a menu of options for external screens on which the video can be played,
wherein upon selecting an external screen from the menu of options, the video is played on the external screen, and
wherein a user can take notes in the note-taking window using the electronic keypad as the video plays on the external screen.

6. A portable device comprising:
a touch-screen display; and
one or more processors configured to output multimedia information in a first area of the touch-screen display, display an electronic keypad in a second area of the touch-screen display, and display in a third area of the touch-screen display a note-taking area in which a user can input notes using the electronic keypad, the notes being associated with the multimedia information.

7. The portable device of claim 6 wherein the one or more processors are further configured to display in the third area time information associated with the note, the time information indicative of a time point within the multimedia information with which the note is associated.

8. The portable device of claim 6 wherein the one or more processors are further configured to:
display a timeline corresponding to the multimedia information in a fourth area of the touch-screen display; and
allow the user to mark on the timeline the time point within the multimedia information with which a user note is associated.

9. A portable device comprising:
a touch screen; and
non-transitory computer storage medium containing computer readable instructions, that when executed, cause the portable device to:
output multimedia information in a first portion of the touch screen;
receive, by the touch screen, user input launching a note-taking mode, the user input corresponding to the multimedia information; and
displaying an electronic keyboard.

10. A computer-readable storage memory storing particular instructions which, when executed by one or more processors, cause the one or more processors to perform operations, the particular instructions comprising:
instructions to cause the one or more processors to receive user input representing one or more characters while concurrently playing a video stream;
instructions to cause the one or more processors to generate and display on a screen on which the video stream is concurrently playing, a first note that includes the one or more characters; and
instructions to cause the one or more processors to store an associative mapping between the first note and a first time point in the video stream.

11. The computer-readable storage memory of claim 10, wherein the particular instructions further comprise:
instructions to cause the one or more processors to receive, while concurrently playing the video stream in a full-screen mode, user input indicating an intent to generate the first note; and
instructions to cause the one or more processors to shrink a presentation of the video stream to a fraction of the screen in response to receiving the user input indicating the intent the generate the first note.

12. The computer-readable storage memory of claim 10, wherein the particular instructions further comprise:
instructions to cause the one or more processors to receive, while concurrently playing the video stream in a full-screen mode, user input indicating an intent to generate the first note; and
instructions to cause the one or more processors to present, in a note-taking window in which the first note is displayed, a thumbnail image of a frame of the video stream that was being presented at a moment that the user input indicating the intent to generate the first note was received;
wherein the first time point corresponds to said moment.

13. The computer-readable storage memory of claim 10, wherein the particular instructions further comprise:
instructions to cause the one or more processors to receive, while concurrently playing the video stream in a full-screen mode, user input indicating an intent to generate the first note; and
instructions to cause the one or more processors to present, in a note-taking window in which the first note is displayed, a timestamp that indicates an elapsed time from a beginning of a presentation of the video stream to at a moment that the user input indicating the intent to generate the first note was received;
wherein the first time point corresponds to said moment.

14. The computer-readable storage memory of claim 10, wherein the particular instructions further comprise:
instructions to cause the one or more processors to receive, while concurrently playing the video stream in a full-screen mode, user input indicating an intent to generate the first note; and
instructions to cause the one or more processors to add, to a timeline displayed on the screen, a first bookmark at a position on the timeline that corresponds to a moment that the user input indicating the intent to generate the first note was received;
wherein the first time point corresponds to said moment.

15. The computer-readable storage memory of claim 14, wherein the particular instructions further comprise:
instructions to cause the one or more processors to present, on the screen while concurrently playing the video stream, a set of multiple list entries, each list entry of said multiple list entries corresponding to a separate note;
wherein a first list entry of the multiple list entries corresponds to the first note;
instructions to cause the one or more processors to move a play head indicator along the timeline as the video stream is playing;
instructions to cause the one or more processors to determine that the play head indicator is coincident with the first bookmark on the timeline; and
instructions to cause the one or more processors to highlight the first list entry in response to determining that the play head indicator is coincident with the first bookmark on the timeline.

16. The computer-readable storage memory of claim 10, wherein the particular instructions further comprise:
instructions to cause the one or more processors to receive, while concurrently playing the video stream in a full-screen mode, user input indicating an intent to generate the first note; and
instructions to cause the one or more processors to present, in a note-taking window in which the first note is displayed, a thumbnail image of a frame of the video stream that was being presented at a moment that the user input indicating the intent to generate the first note was received;
wherein the first time point corresponds to said moment;
instructions to cause the one or more processors to receive, while concurrently playing the video stream in a fraction of the screen, user input indicating an intent to generate a second note that is separate from the first note; and
instructions to cause the one or more processors to present, in the note-taking window in a list entry for the second note, a thumbnail image of a frame of the video stream that was being presented at a second moment that the user input indicating the intent to generate the second note was received.

17. The computer-readable storage memory of claim 10, wherein the particular instructions further comprise:
instructions to cause the one or more processors to receive, while concurrently playing the video stream in a full-screen mode, user input indicating an intent to generate the first note; and
instructions to cause the one or more processors to present, in a note-taking window in which the first note is displayed, a timestamp that indicates an elapsed time from a beginning of a presentation of the video stream to at a moment that the user input indicating the intent to generate the first note was received;
wherein the first time point corresponds to said moment;
instructions to cause the one or more processors to receive, while concurrently playing the video stream in a fraction of the screen, user input indicating an intent to generate a second note that is separate from the first note; and
instructions to cause the one or more processors to present, in the note-taking window in a list entry from the second note, a timestamp that indicates an elapsed time from the beginning of the presentation of the video stream to at a moment that the user input indicating the intent to generate the second note was received.

18. The computer-readable storage memory of claim 10, wherein the particular instructions further comprise:
instructions to cause the one or more processors to receive, while concurrently playing the video stream in a full-screen mode, user input indicating an intent to generate the first note; and
instructions to cause the one or more processors to add, to a timeline displayed on the screen, a first bookmark at a position on the timeline that corresponds to a moment that the user input indicating the intent to generate the first note was received;
wherein the first time point corresponds to said moment;
instructions to cause the one or more processors to receive, while concurrently playing the video stream in a fraction of the screen, user input indicating an intent to generate a second note that is separate from the first note; and
instructions to cause the one or more processors to add, to the timeline, a second bookmark at a position on the timeline that corresponds to a moment that the user input indicating the intent to generate the second note was received.

19. The computer-readable storage memory of claim 15, wherein the particular instructions further comprise:
instructions to cause the one or more processors to present, on the screen while concurrently playing the video stream, a set of multiple list entries, each list entry of said multiple list entries corresponding to a separate note;
wherein a first list entry of the multiple list entries corresponds to the first note;
wherein a second list entry of the multiple list entries corresponds to the second note;
instructions to cause the one or more processors to move a play head indicator along the timeline as the video stream is playing;
instructions to cause the one or more processors to determine that the play head indicator is coincident with the first bookmark on the timeline;
instructions to cause the one or more processors to highlight the first list entry but not the second list entry in response to determining that the play head indicator is coincident with the first bookmark on the timeline;
instructions to cause the one or more processors to determine that the play head indicator is coincident with the second bookmark on the timeline; and
instructions to cause the one or more processors to highlight the second list entry but not the first list entry in response to determining that the play head indicator is coincident with the second bookmark on the timeline.
